(19) United States
(12) Patent Application Publication
(10) Pub. No.: US 2014/0365311 A1
(43) Pub. Date: Dec. 11, 2014

(54) Associating Advertisements with Events

(71) Applicant: Facebook, Inc, Menlo Park, CA (US)

(72) Inventors: Max Eulenstein, San Francisco, CA (US); Deborah Liu, Palo Alto, CA (US); Vijaye Raji, Palo Alto, CA (US)

(21) Appl. No.: 13/914,884

(22) Filed: Jun. 11, 2013

(51) Int. Cl. G06Q 30/02

(52) U.S. Cl. CPC G06Q 30/0269
USPC 705/14.66

(57) ABSTRACT

In one embodiment, a method includes receiving a notification identifying the occurrence of a user-initiated event associated with a software application that complies with the specifications of a software development kit. The user is identified based at least in part on the information included the notification. The method includes determining whether the event is attributable to an electronic advertisement, and when the event is attributable to the advertisement, the method include determining whether the electronic advertisement is associated with information identifying the advertisement or an advertising campaign that the advertisement is a part of When the electronic advertisement is associated with the information, the method includes notifying an advertiser associated with the electronic advertisement or a developer associated with the software application that the information identifying the advertisement is associated with the event.

### TECHNICAL FIELD

This disclosure generally relates to electronic advertising.

### BACKGROUND

Electronic advertising spaces provide advertisers with a venue for displaying electronic advertisements to consumers of the advertisement. Electronic advertising spaces may exist on electronic displays of various sizes. Displays may exist on mobile devices (such as smart phones), laptops, personal computers, televisions, kiosks, and billboards. Electronic advertisements may be delivered to a device from various entities, such as directly from the advertiser, from an agent of the advertiser (such as an advertising clearinghouse), or from the operator of an advertisement bidding system. The operator of an advertisement bidding system may accept or request one or more bids from one or more advertisers to place an advertisement in one or more advertising spaces

### SUMMARY OF PARTICULAR EMBODIMENTS

For advertisers and developers of software applications, tracking user-initiated events related to those software applications and correlating those events with particular users and advertisements and/or ad campaigns is an important part of the advertiser's or developer's analytics platform. Software applications may be any suitable software application accessible by a client device. An advertiser may track and correlate events by “tagging” an electronic advertisement with some information specific to the advertisement or the ad campaign the advertisement is a part of Tagging may be accomplished by any suitable method, such as for example by associating the identifying information with the advertisement that identifies or describes that information. In particular embodiments, that information may be part of the advertisement, and may be either displayed in some form to a user or invisible to the user. For example, an ad campaign for a game may be based on offering discounted in-game purchases to a potential customer, and each ad in the campaign may describe the offered discount associated with the campaign.

When a user-initiated event involving the software application occurs, a notification is received (e.g. at a server computing device) that includes information related to the identity of the user associated with event and the identity of the event. The identity of the user is determined, and a determination is made as to whether the event was attributable to an advertisement (e.g., because the user clicked on the advertisement). If the event was attributable to the advertisement, a determination is made as to whether information associated with the advertisement identifies that advertisement or the ad campaign the advertisement is a part of. If that information does exist, then the advertiser or developer is notified that the information (i.e., the ad or ad campaign) is associated with the occurrence of the event.

### BRIEF DESCRIPTION OF THE DRAWINGS

FIG. 1 illustrates an example network environment associated with a social-networking system.

FIG. 2 illustrates an example method for associating an advertisement with an event.

FIG. 3 illustrates an example computer system.

### DESCRIPTION OF EXAMPLE EMBODIMENTS

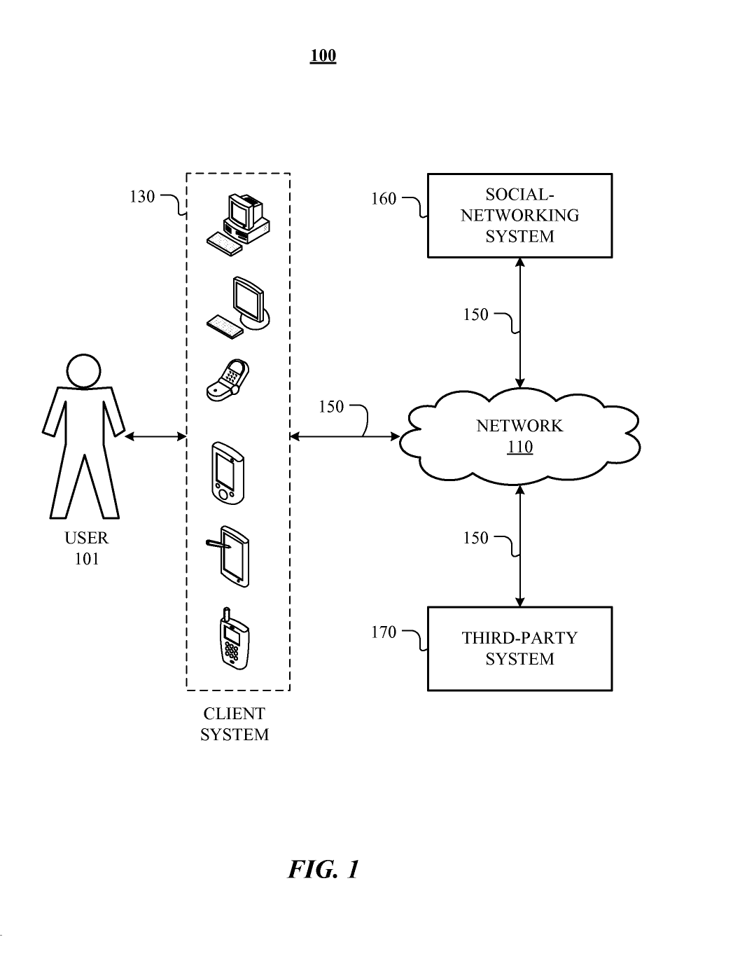

FIG. 1 illustrates an example network environment 100 associated with a social-networking system. Network environment 100 includes a user 101, a client system 130, a social-networking system 160, and a third-party system 170 connected to each other by a network 110. Although FIG. 1 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple users 101, client system 130, social-networking systems 160, third-party systems 170, and networks 110.

In particular embodiments, user 101 may be an individual (human user), an entity (e.g., an enterprise, business, or third-party application), or a group (e.g., of individuals or entities) that interacts or communicates with or over social-networking system 160. In particular embodiments, social-networking system 160 may be a network-addressable computing system hosting an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include an authorization server (or other suitable component(s)) that allows users 101 to opt in to or opt out of having their actions logged by social-networking system 160 or shared with other systems (e.g., third-party systems 170), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 30 through blocking, data hashing, anonymization, or other suitable techniques as appropriate. In particular embodiments, third-party system 170 may be a network-addressable computing system. Third-party system 170 may generate, store, receive, and send third-party system data. Third-party system 170 may be accessed by the other components of network environment 100 either directly or via network 110. In particular embodiments, one or more users 101 may use one or more client systems 130 to access, send data to, and receive data from social-networking system 160 or third-party system 170. Client system 130 may access social-networking system 160 or third-party system 170 directly, via network 110, or via a third-party system. As an example and not by way of limitation, client system 130 may access third-party system 170 via social-networking system 160. Client system 130 may be any suitable computing device, such as, for example, a personal computer, a laptop computer, a cellular telephone, a smartphone, or a tablet computer.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, social-networking system 160 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 whom they want to be connected to. Herein, the term “friend” may refer to any other user of social-networking system 160 with whom a user has formed a connection, association, or relationship via social-networking system 160.

For advertisers and developers of software applications, tracking user-initiated events related to those software applications and correlating those events with particular users, advertisements, and/or ad campaigns is an important part of the advertiser's or developer's analytics platform. Software applications may be any suitable software application accessible by a client device, such as a software application stored at least in part on the client device, executable at least in part on the client device, or communicating with the client device. An advertiser may track and correlate events by “tagging” an electronic advertisement with some information specific to the advertisement or the ad campaign the advertisement is a part of. Tagging may be accomplished by any suitable method, such as for example by associating the identifying information with the advertisement that identifies or describes that information. In particular embodiments, that information may be part of the advertisement, and may be either displayed in some form to a user or invisible to the user. For example, an ad campaign for a game may be based on offering discounted in-game purchases to a potential customer, and each ad in the campaign may describe the offered discount associated with the campaign. In addition or the alternative, different ads may offer different types or amounts of discounts, and each of those ads may be identified by a unique tag. In particular embodiments, more than one tag may be associated with an advertisement (e.g. a tag identifying an ad campaign and a tag identifying a particular ad, etc.).

User-initiated events may be any suitable event involving the software application. In particular embodiments, an event may be an installation of the software application on a client device. In particular embodiments, an event may be using a functionality of the software application. For example, using a tool to add a certain effect to a photo in a photo-editing software application or using a particular item in a game may be an event. In particular embodiments, an event may be an amount of time spent using the software application. For example, using the application for an hour may be one event, and using the application for 10 hours may be another event. In particular embodiments, an event may be use of the application, such as loading the application or executing the application in the memory of the client computing device. In particular embodiments, an event may be an amount of use of the application. For example, an event may be reaching a particular level or event in a game, using a particular amount of functionality in a database-management application, or editing a certain number of photos. In particular embodiments, an event may be a suitable combination of events. While this disclosure describes particular examples of particular types of events, this disclosure contemplates any suitable user-initiated event associated with the software application.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 160). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 160 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 160) or RSVP (e.g., through social-networking system 160) to an event associated with the advertisement. In addition or as an alternative, an advertisement may include social-networking-system context directed to the user. As an example and not by way of limitation, an advertisement may display information about a friend of the user within social-networking system 160 who has taken an action associated with the subject matter of the advertisement.

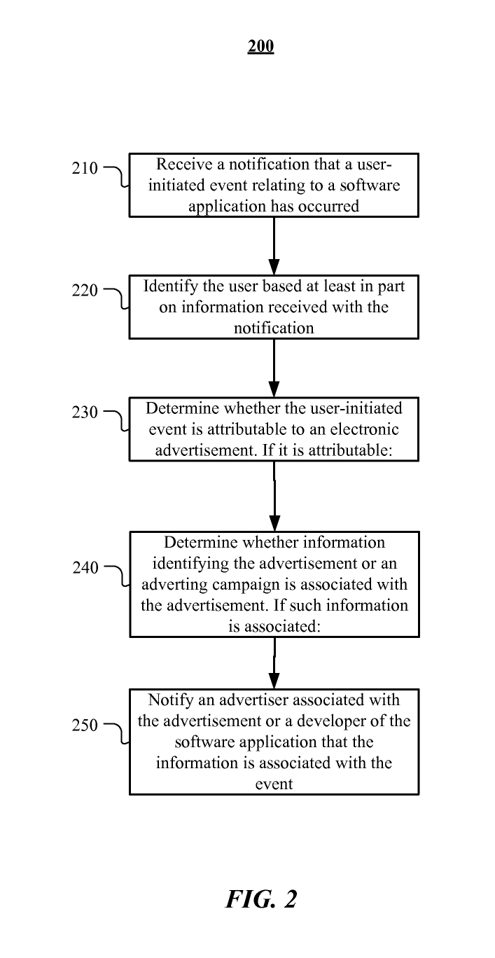

FIG. 2 illustrates an example method 200 for associating an advertisement with an event. The method may begin at step 210, where a notification associated with an event is received by computing device. The receiving computing device may be any suitable computing device, such as the client computing device; a computing device associated with an ad publisher; a computing devices associated with network 110, third-party system 170, or social networking system 160; any suitable combination thereof; or any other suitable computing device. The notification may be sent by the client device, the advertiser or developer of the software application, a third-party analytics or advertising vender, or any other suitable entity.

In particular embodiments, the notification may comply with the specifications of a software development kit for the software application. The software development kit may be supplied by any suitable entity, such as an advertiser, an analytics service provider, an ad publisher, an operating system, a developer of a software application, or a social-networking system. In particular embodiments, the specifications of the software development kit may specify the format for the notification, when notifications should be made, protocols for providing notifications, etc. In particular embodiments, as part of implementing the software development kit the developer of the software application may have to agree to a terms of service governing the implementation the software application and the use of user information obtained by the application.

In particular embodiments, a notification includes information identifying the user associated with the user-initiated event. For example, the information may identify the user directly, such as with the user's name, with a unique ID number associated with the user (e.g. an ID number associated with a social network), or with a hash or other encoded information uniquely associated with the user. As another example, the information may indirectly identify the user. For example, the information may identify the user's client device (e.g. by an addressable hardware component, an account associated with the device, etc), which may be correlated with that user (e.g. by a cookie associated with the user and residing on the same device, by an account associated with the user and the device, etc.). Information identifying a user and/or a client device may use any of the methods for tracking mobile application or mobile device information described in patent application Ser. No. 13/748,560 titled “Conversion Tracking for Installation of Applications on Mobile Devices” and filed 23 Jan. 2013, which is incorporated by reference herein. While this disclosure provides specific examples of information and methods identifying a user associated with a user-initiated event, this disclosure contemplates any suitable information and methods identifying that user. In particular embodiments, privacy settings may allow a user to control what information (if any) identifying the user may be included with a notification. When the notification includes information identifying the user associated with the user-initiated event, method 200 includes identifying the user associated with the event based at least in part on the information identifying the user, as illustrated in step 220 and described above.

At step 230, a determination is made as to whether the event associated with the notification received in step 210 is attributable to an electronic advertisement. For example, the entity receiving the notification may be an ad publisher or communicate with an ad publisher to determine an identified user's interactions with specific advertisements or advertising campaigns. In particular embodiments, determining whether the event is attributable to the advertisement includes determining whether the user has perceived the advertisement. For example, the user may be determined to have perceived the advertisement when the user selects the ad, for example by clicking (or tapping, on a touch-sensitive display) on the ad and being redirected to the appropriated land page. As another example, the user may be determined have perceived the ad when the ad has been displayed to the user, for example on a webpage the user has visited, in an application the user was running, in an email the user opened, etc. As another example, the user may be determined to have perceived the ad when the user's actions indicated some awareness of the ad. For example, the user may indicate awareness by pausing scrolling of a webpage or email on a portion of the webpage or email that contains the ad, by pausing an application or use of application when an ad is displayed, by hovering e.g. a cursor over the advertisement, by interacting with advertisement (e.g. by “liking” the advertisement or other social action with the ad), or any other suitable indication that the user is aware of the ad. In particular embodiments, determining whether the event is attributable to an advertisement includes determining whether the user has perceived the advertisement within a predetermined timeframe (e.g. 30 days) prior to the event. In particular embodiments, a weight may be applied to a user's perception of an ad. For example, more recent perceptions (relative to an event) may be given higher weights, meaning that an event may be determined to be more likely attributable to an ad when the ad was perceived by the user more recently relative to the event. As another example, a more definitive determination that the user has perceived an ad (e.g. selecting the ad rather than simply viewing the ad) may be given a higher weight. In particular embodiments, if an event is not attributable to an advertisement, the advertiser or developer may notified of that fact. This disclosure describes specific example of determining whether an event is attributable to an electronic advertisement, this disclosure contemplates any suitable method of determining that an event is attributable to an electronic advertisement.

If an event is attributable to an advertisement, method 200 may include a determination about whether information associated with the advertisement identifies the advertisement or an advertising campaign that the advertisement is a part of, as illustrated in step 240. In particular embodiments, the information may be part of the advertisement, such as one or more character strings (numbers, letters, symbols, etc.), whether or not those strings are displayed to the user through the advertisement. For example, such information may be a string that states “Buy Software Application Now! Receive 10% off!”, which identifies the advertisement (if that text is unique to that advertisement) or the ad campaign (e.g. a “10% off” campaign). As another example, such information may be an advertiser or developer generated string, such as “This ad is part of the 10% off campaign” or “this ad [or ad campaign] offers the user 100 coins in a game”. In particular embodiments, the information may not be part of the advertisement but may be otherwise associated with the ad. For example, an advertiser may submit a description of the advertisement or ad campaign with the ad to the ad publisher, and that description may be referenced when the ad is determined to be associated with the event (as described in step 230, above). In particular embodiments, the information may be an offer associated with an advertisement or ad campaign and related to the software application, may be an aspect of a targeted advertisement or ad campaign, may be a description of the advertisement or ad campaign, or may be any other suitable information identifying the ad or ad campaign. While this disclosure describes specific examples of associating information with an advertisement, this disclosure contemplates any suitable method of associating that information with an advertisement.

When a determination is made that information identifying an ad or ad campaign is associated with the advertisement of step 230, a notification is sent to the advertiser of the ad, and/or the developer of the software application, that the information is associated with the event, as illustrated in step 250. In particular embodiments, that notification is simply the information itself, such as a descriptive string identifying the ad or ad campaign. In particular embodiments, that notification may be derived from the information discussed in step 240, such as a label associated with an ad campaign determined from the information in step 240. This disclosure contemplates any suitable method of notifying an advertiser or developer that the information is associated with the event.

Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

Once an advertiser or developer is able to correlate which ads or ads campaigns are associated with particular events initiated by particular user, the advertiser can use that information to generate more effective ads and ad campaigns, both for users correlated to events and for other user having one or more similar characteristics as the users correlated to events. For example, particular embodiments may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. In the context of a social-networking system, an advertiser may use user-profile information in social-networking system 160 to identify those users. In addition or as an alternative, social-networking system 160 may use user-profile information in social-networking system 160 to identify those users for the advertiser. As examples and not by way of limitation, particular embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 160, off or outside of social-networking system 160, or on mobile computing devices of users. When on or within social-networking system 160, such targeting may be directed to users' news feeds, search results, e-mail or other in-boxes, or notifications channels or may appear in particular area of web pages of social-networking system 160, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 160, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 160 or explicit connections of a user to a node, object, entity, brand, or page on social-networking system 160. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. 2009/0119167, entitled “Social Advertisements and Other Informational Messages on a Social Networking Website and Advertising Model for Same” and filed 18 Aug. 2008 as U.S. patent application Ser. No. 12/193,702; U.S. Patent Application Publication No. 2009/0070219, entitled “Targeting Advertisements in a Social Network” and filed 20 Aug. 2008 as U.S. patent application Ser. No. 12/195,321; U.S. Patent Application Publication No. 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. 2012/0166532, entitled “Contextually Relevant Affinity Prediction in a Social-Networking System” and filed 23 Dec. 2010 as U.S. patent application Ser. No. 12/978,265.

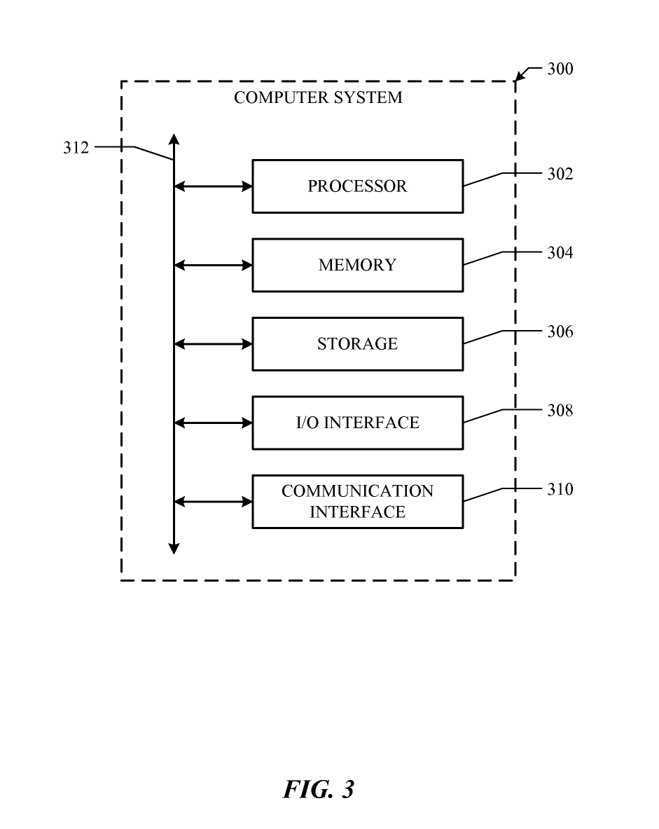

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
receiving, by a computing device, a notification complying with one or more specifications of a software development kit, the notification comprising:
first information associated with an identity of a user; and
second information identifying the occurrence of a event associated with a software application and initiated by the user;
identifying, by the computing device, the user based at least in part on the first information;
determining, by the computing device, whether the event is attributable to an electronic advertisement; and
when the event is attributable to the advertisement:
determining, by the computing device, whether the electronic advertisement is associated with third information identifying the advertisement or an advertising campaign associated with the advertisement; and
when the electronic advertisement is associated with the third information, notifying, by the computing device, an advertiser associated with the electronic advertisement or a developer associated with the software application that the third information is associated with the event.

2. The method of claim 1, wherein the electronic advertisement comprises an advertisement displayed on a mobile client computing device.

3. The method of claim 1, wherein the third information identifies an advertising campaign associated with the advertisement.

4. The method of claim 1, wherein the third information identifies an offer associated with the software application.

5. The method of claim 1, wherein the advertisement comprises the third information.

6. The method of claim 1, wherein the event comprises an installation of the software application on a client computer computing device.

7. The method of claim 1, wherein the event comprises one or more of:
a use of the software application;
a use of a functionality of the software application;
an amount of time spent interacting with the software application; or
an amount of use of the software application.

8. The method of claim 1, wherein determining whether the event is attributable to an electronic advertisement comprises determining whether the user has perceived the advertisement.

9. The method of claim 8, wherein determining that the user has perceived the advertisement comprises determining that the user has:
selected the advertisement;
viewed the advertisement; or
indicated that the user is aware of the ad.

10. The method of claim 8, wherein the determining whether the event is attributable to an electronic advertisement further comprises determining whether the user has perceived the advertisement within a predetermined timeframe prior to the event.

11. The method of claim 1, further comprising:
when the electronic advertisement is not associated with the third information, notifying, by the computing device, the advertiser associated with the electronic advertisement or the developer associated with the software application that there is no third information associated with the event.

12. One or more computer-readable non-transitory storage media embodying software that is operable when executed to:
receive a notification complying with one or more specifications of a software development kit, the notification comprising:
first information associated with an identity of a user; and
second information identifying the occurrence of a event associated with a software application and initiated by the user;
identify the user based at least in part on the first information;
determine whether the event is attributable to an electronic advertisement; and
when the event is attributable to the advertisement:
determine whether the electronic advertisement is associated with third information identifying the advertisement or an advertising campaign associated with the advertisement; and
when the electronic advertisement is associated with the third information, notify an advertiser associated with the electronic advertisement or a developer associated with the software application that the third information is associated with the event.

13. The media of claim 12, wherein the electronic advertisement comprises an advertisement displayed on a mobile client computing device.

14. The media of claim 12, wherein the third information identifies an advertising campaign associated with the advertisement.

15. The media of claim 12, wherein the third information identifies an offer associated with the software application.

16. The media of claim 12, wherein the event comprises an installation of the software application on a client computer computing device.

17. The media of claim 12, wherein the event comprises one or more of:
a use of the software application;
a use of a functionality of the software application;
an amount of time spent interacting with the software application; or
an amount of use of the software application.

18. The media of claim 12, wherein the software that is operable when executed to determine whether the event is attributable to an electronic advertisement comprises software that is operable when executed to determine whether the user has perceived the advertisement.

19. The media of claim 18, wherein the software that is operable when executed to determine that the user has perceived the advertisement comprises software that is operable when executed to determine that the user has:
selected the advertisement;
viewed the advertisement; or
indicated that the user is aware of the ad.

20. A system comprising:
one or more processors; and
a memory coupled to the processors comprising instructions executable by the processors, the processors being operable when executing the instructions to:
receive a notification complying with one or more specifications of a software development kit, the notification comprising:
first information associated with an identity of a user; and
second information identifying the occurrence of a event associated with a software application and initiated by the user;
identify the user based at least in part on the first information;
determine whether the event is attributable to an electronic advertisement; and
when the event is attributable to the advertisement:
determine whether the electronic advertisement is associated with third information identifying the advertisement or an advertising campaign associated with the advertisement; and
when the electronic advertisement is associated with the third information, notify an advertiser associated with the electronic advertisement or a developer associated with the software application that the third information is associated with the event.
